(19) United States
(12) Patent Application Publication
(10) Pub. No.: US 2020/0278839 A1
(43) Pub. Date: Sep. 3, 2020

(54) True Random Number Generator of a Field Programmable Gate Array

(71) Applicants: Goke Taiwan Research Laboratory Ltd., Taipei City (TW); Xinshing Intelligent Technology Co., Ltd., JIANGSU (CN)

(72) Inventors: Po-Chien Chang, Taipei City (TW); Jui-Hsien Yen, Hsinchu City (TW)

(21) Appl. No.: 16/289,765

(22) Filed: Mar. 1, 2019

(51) Int. Cl. G06F 7/58

(52) U.S. Cl. CPC G06F 7/588; G06F 21/76

(57) ABSTRACT

A true random number generator of a field programmable gate array includes a random source set, an environmental sensor set, a sampling controller and an entropy harvester. The random source set provides random signals. The environmental sensor set provides environmental signals. The sampling controller is connected to the random source set and the environmental sensor set. The entropy harvester is connected to the random source set and the sampling controller so that the entropy harvester generates random numbers based on the random signals and the environmental signals.

### BACKGROUND OF INVENTION

### 1. Field of Invention

The present invention relates to generation of random numbers and, more particularly, to a true random number generator of a field programmable gate array.

### 2. Related Prior Art

A random number generator generates random numbers that can be used to protect the security of data. Some random number generators generate random numbers that can hardly be predicted, and these random number generators are referred to as ‘true random number generators.’ Other random number generators generate random numbers that can be detected relatively easily, and they are called ‘pseudo random number generators.’ Typically, a true random number generator is used in an application-specific integrated circuit (‘ASIC’). There is hardly any field programmable gate array (‘FPGA’) that effectively incorporates a true random number generator. Hence, a field programmable gate array is bound to use a pseudo random number generator and hence cannot secure its data effectively.

US20110169579A1 discloses a random number generator including two random sources. One of the random sources is a high-frequency oscillator 71 and the other random source is a low-frequency oscillator 72. However, it fails to disclose generation of true random numbers in FPGA.

US20150019605A1 discloses a random number generator using two phase-locked loops (‘PLL’s) as random sources. However, it fails to disclose generation of true random numbers in FPGA.

WO2014007583A1 discloses a random number generator using a physical data base (‘PDB’) path 110 as a random source and a binary counter 140 to delay signals that come from the PDB path 110. However, it discloses only one random source and hence needs a compensating circuit to improve randomness.

CN101515228A discloses a random number generator including a random source module 1 and a post-processing module 2. The random source module 1 uses multiple ring oscillators 31, 32, . . . and 3N as random sources. The random source module 1 uses an exclusive or gate 4 to process signals that come from the ring oscillator. The random source module 1 uses a sampler 5 to sample signals that come from the exclusive or gate 4 and accordingly provide signals deemed original random numbers. The post-processing module 2 processes the original random numbers and accordingly provides signals deemed random numbers. However, it fails to disclose generation of true random numbers in FPGA.

Therefore, the present invention is intended to obviate or at least alleviate the problems encountered in prior art.

### SUMMARY OF INVENTION

It is the primary objective of the present invention to provide an FPGA with a true random number generator.

To achieve the foregoing objective, the true random number generator of the FPGA includes a random source set, an environmental sensor set, a sampling controller and an entropy harvester. The random source set provides random signals. The environmental sensor set provides environmental signals. The sampling controller is connected to the random source set and the environmental sensor set. The entropy harvester is connected to the random source set and the sampling controller so that the entropy harvester generates random numbers based on the random signals and the environmental signals.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a block diagram of a true random number generator of a FPGA according to the preferred embodiment of the present invention;

FIG. 2 is a block diagram of a first internal random source of the true random number generator shown in FIG. 1;

FIG. 3 is a block diagram of a ring oscillator of the first internal random source shown in FIG. 2;

FIG. 4 is a block diagram of a second internal random source of the true random number generator shown in FIG. 1;

FIG. 5 is a block diagram of a third internal random source of the true random number generator shown in FIG. 1;

FIG. 6 shows the operating principle of the third internal random source shown in FIG. 5;

FIG. 7 is a block diagram of a configurable signal generator for an inverter of the first internal random source, a delaying circuit of the second internal random source and an inverter and delaying circuit of the third internal random source; and

FIG. 8 is a block diagram of environmental sensor set of the true random number generator shown in FIG. 1.

### DETAILED DESCRIPTION OF PREFERRED EMBODIMENT

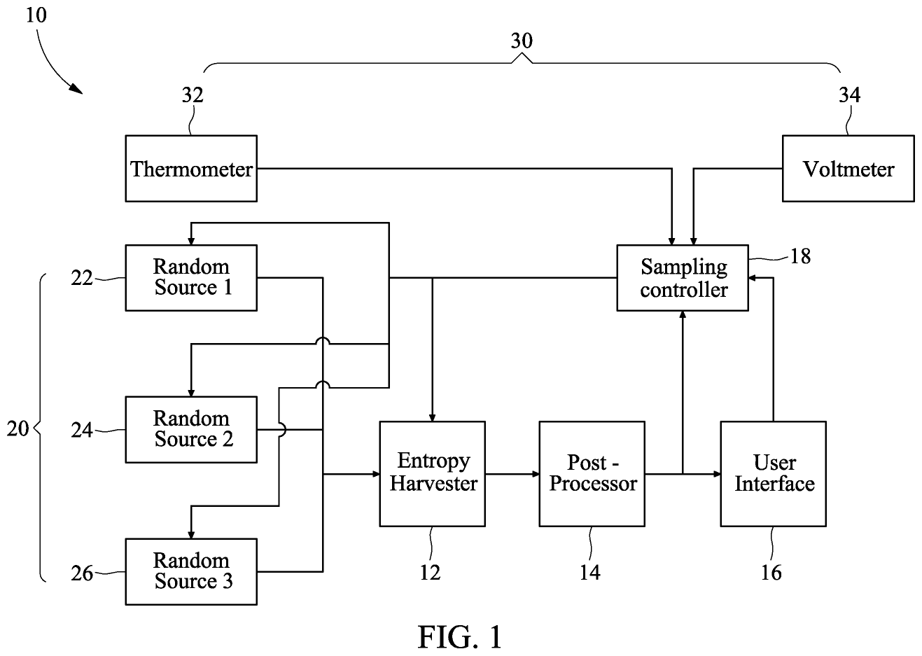

Referring to FIG. 1, a true random number generator 10 includes an entropy harvester 12, a post-processor 14, a user interface 16, a sampling controller 18, a random source set 20 and an environmental sensor set 30 according to the preferred embodiment of the present invention. The random number generator 10 is made part of a FPGA. The true random number generator 10 can be used in a data storage apparatus or any other proper apparatus. The true random number generator 10 and such an apparatus form a system.

In the preferred embodiment, the random source set 20 includes three random sources 22, 24 and 26 all connected to the entropy harvester 12. Hence, the random sources 22, 24 and 26 provide random signals to the entropy harvester 12. In another embodiment, the random source set 20 can include another number of random sources or other types of random sources. All the random sources are connected to the entropy harvester 12 regardless of their total number and types.

The environmental sensor set 30 detects at least one environmental condition and sends at least one corresponding signal. The environmental sensor set 30 provides random signals that can hardly be predicted. In the preferred embodiment, the environmental sensor set 30 includes a thermometer 32 and a voltmeter 34. The thermometer 32 and the voltmeter 34 are connected to the sampling controller 18. The thermometer 32 measures temperature of the system and sends a corresponding signal to the sampling controller 18. The voltmeter 34 measures voltage of the system and sends a corresponding signal to the sampling controller 18. In another embodiment, the environmental sensor set 30 can include another number of environmental sensors or other types of environmental sensors. No matter how many environmental sensors or what types of environmental sensors are used, all of them are connected to the sampling controller 18.

The entropy harvester 12 is connected to the post-processor 14. The post-processor 14 is connected to the user interface 16 and the sampling controller 18. The user interface 16 is further connected to the sampling controller 18. The sampling controller 18 is further connected to the entropy harvester 12 and the random source set 20.

The entropy harvester 12 receives the random signals from the random source set 20, and receives the environmental signals from the environmental sensor set 30 via the sampling controller 18. The entropy harvester 12 generates random numbers based on the random signals and the environment signals.

The post-processor 14 receives the random numbers from the entropy harvester 12 and renders them in a format required by the system. Furthermore, the post-processor 14 provides the sampling controller 18 with feedback to be used as at least one unpredictable control signal for the random source set 20.

The user interface 16 transfers the random numbers to the system in the format required by the system. Furthermore, the user interface 16 receives system signals and provides the sampling controller 18 with feedback to be used as at least one unpredictable control signal for the random source set 20.

As described above, the environmental sensor set 30 provides the environmental signals to improve the unpredictability of the random numbers. The feedback from the post-processor 14 further improves the unpredictability of the random numbers. The feedback from the user interface 16 further improves the unpredictability of the random numbers.

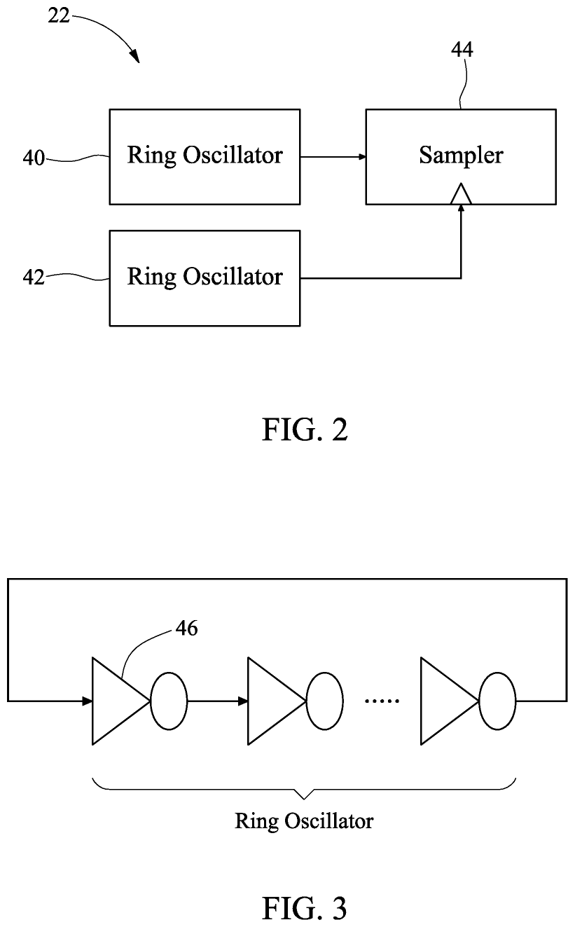

Referring to FIGS. 2 and 3, the random source 22 includes two ring oscillators 40 and 42 and a sampler 44. The ring oscillators 40 and 42 are connected to the sampler 44. Each of the ring oscillators 40 and 42 includes multiple inverters 46 connected to one another in serial. Each of the inverters 46 includes a plurality of configurable signal generators 48 (FIG. 7). The ring oscillator 40 generates a clock signal. The ring oscillator 42 generates another clock signal. The clock signal generated by the ring oscillator 40 is used as data of the sampler 44. The clock signal generated by the ring oscillator 42 is used as a clock signal of the sampler 44. The frequency of the clock signal generated by the ring oscillator 40 is different from that of the clock signal generated by the ring oscillator 42. Furthermore, clock jitter is unpredictable. Data sampled by the sampler 44 falls in a range of meta-stability and an unpredictable random source is made.

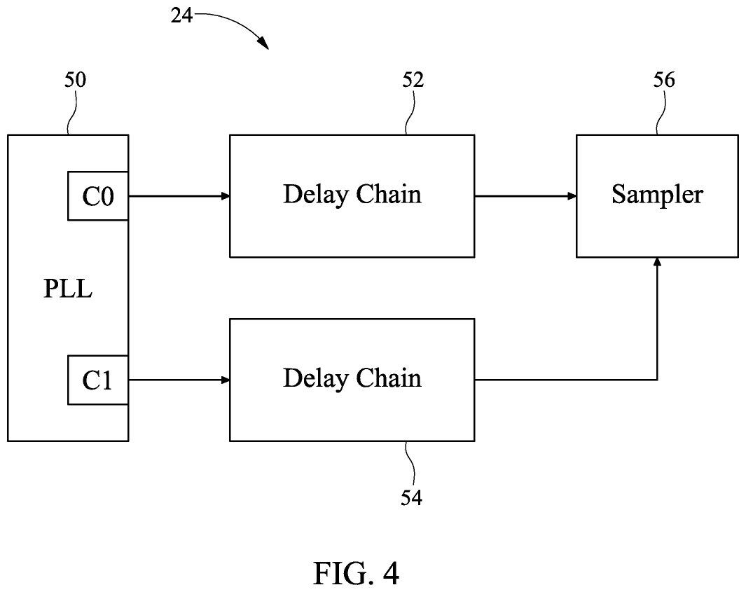

Referring to FIG. 4, the random source 24 includes a phase-locked loop (‘PLL’) 50, two delaying circuits 52 and 54 and a sampler 56. The phase-locked loop 50 is made part of the FPGA. The phase-locked loop 50 provides two clock signals C0 and C1. The clock signal C1 is used as a clock signal of a sampling logic. The clock signal C0 is used as data of the sampling logic. As mentioned above, the clock jitter is unpredictable. Hence, it cannot be predicted whether the sampled data falls in a range of meta-stability, and unpredictable data is generated. The clock signal C0 is sent to the delaying circuit 52. The clock signal C1 is sent to the delaying circuit 54. Each of the delaying circuits 52 and 54 includes a plurality of configurable signal generators 48.

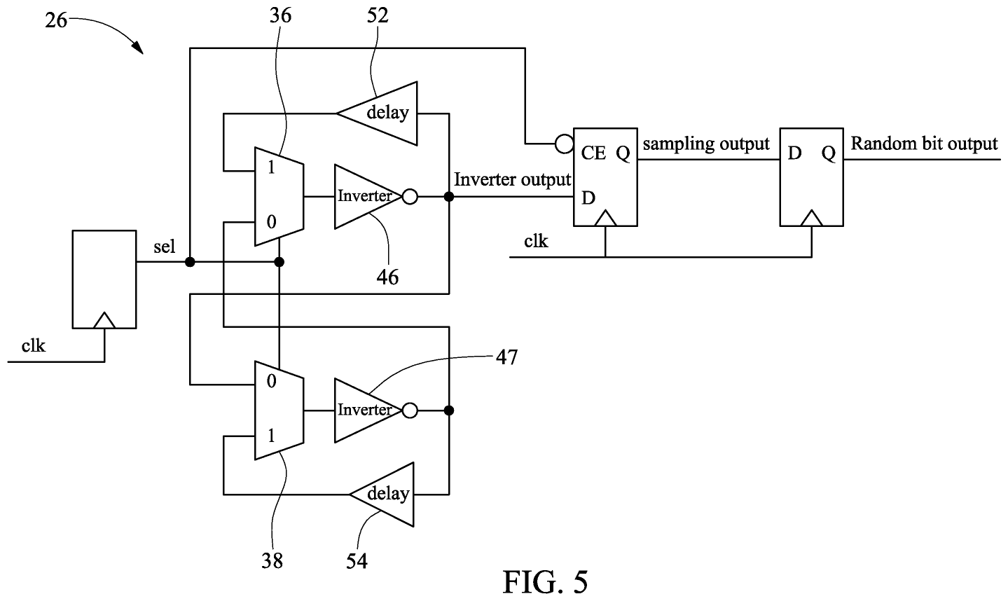

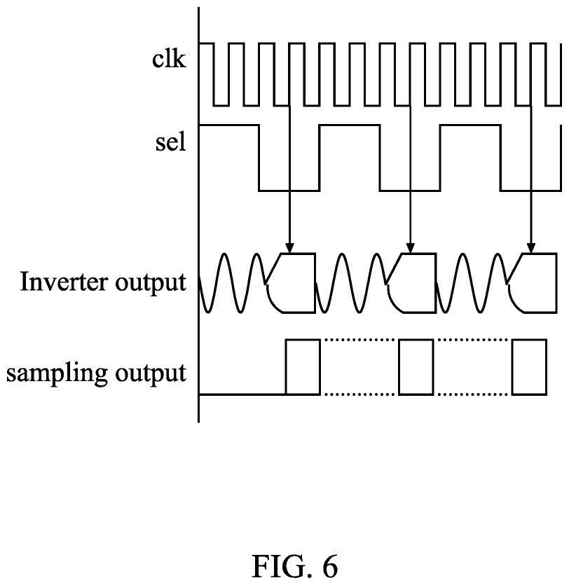

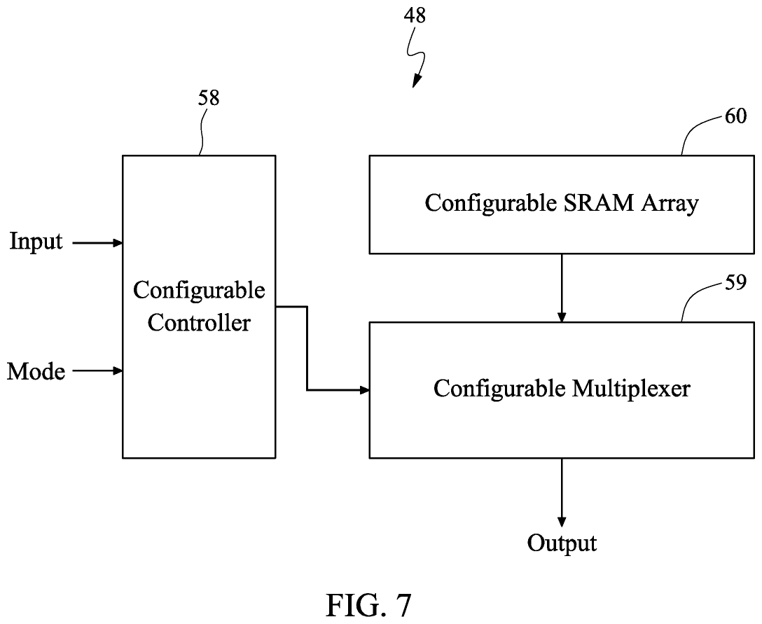

Referring to FIGS. 5 and 6, the random source 26 is a meta-stability random source that includes two multiplexers 36 and 38, two inverters 46 and 47, and two delaying circuits 52 and 54. The multiplexer 36, the inverter 46 and the delaying circuits 52 are connected to one another. The multiplexer 38, the inverter 47 and the delaying circuit 54 are connected to one another. Each of the inverters 46 and 47 generates a signal that oscillates between 0 and 1 when the control signal is true (digital 1). An output of the inverter 46 is connected to an input of the multiplexer 38, and an output of the inverter 47 is connected to an input of the multiplexer 36 when the control signal is false (digital 0). Now, the input and output of the inverters 46 and 47 are unpredictable. Confliction of logic states causes meta-stability and the state of the output of the inverter 46 is unpredictable after mean time between failures (‘MTBF’) elapses so that a number sampled in a sampling register is unpredictable. Hence, true random numbers are generated.

Referring to FIG. 7, each of the inverters 46 and 47 and each of the delaying circuits 52 and 54 can include multiple configurable signal generators 48. Each of the configurable signal generators 48 provides delayed or inverted input signal according to the mode, and includes at least one configurable controller 58, at least one configurable multiplexer 59 and at least one configurable static random access memory (‘SRAM’) array 60. The configurable controller 58, the configurable multiplexer 59 and the configurable SRAM array 60 are not limited to any amount or type. Dynamically, the configurable controller 58 selects one output path of the configurable multiplexer 59 to achieve various delaying effects and avoid physical bias, thereby rendering the signal unpredictable.

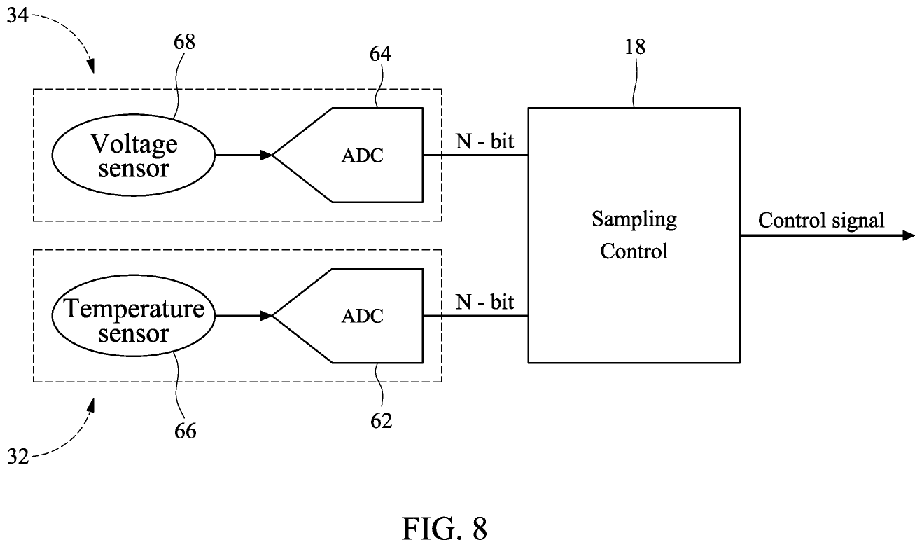

Referring to FIG. 8, the thermometer 32 is connected to the sampling controller 18. The thermometer 32 includes a temperature sensor 66 and an analog-to-digital converter (‘ADC’) 62 of the FPGA. The voltmeter 34 is connected to the sampling controller 18. The voltmeter 34 comprises a voltage sensor 68 and an ADC 64 of the FPGA. The ADCs 62 and 64 are substantially identical to each other. Thus, the ADCs 62 and 64 of the thermometer 32 and the voltmeter 34 convert signals to digital from analog, thereby facilitating the sampling controller 18 to process.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A true random number generator of a field programmable gate array comprising:
a random source set (20) for providing random signals;
an environmental sensor set (30) for providing environmental signals;
a sampling controller (18) connected to the random source set (20) and the environmental sensor set (30); and
an entropy harvester (12) connected to the random source set (20) and the sampling controller (18) so that the entropy harvester (12) generates random numbers based on the random signals and the environmental signals.

2. The true random number generator according to claim 1, wherein the random source set (20) comprises a first random source (22), a second random source (24) and a third random source (26).

3. The true random number generator according to claim 2, wherein the first random source (22) comprises:
two ring oscillators (40, 42) each of which comprises inverters (46) connected to one another in serial, wherein each of the inverters (46) comprises configurable signal generators (48); and
a sampler (44) connected to the ring oscillators (40, 42).

4. The true random number generator according to claim 3, wherein each of the configurable signal generators (48) provides a delayed or inverted input signal according to the mode and comprises a configurable controller (58), a configurable multiplexer (59) and a configurable static random access memory array (60) connected to one another, wherein the configurable controller (58) automatically selects an output path of the configurable multiplexer (59) to achieve various delaying effects and avoid physical bias, thereby rendering the signal unpredictable.

5. The true random number generator according to claim 2, wherein the second random source (24) comprises:
a phase-locked loop (50) comprising two clocks (C0, C1);
two delaying circuits (52, 54) connected to the clocks (C0, C1) respectively, wherein each of the delaying circuits (52, 54) comprises configurable signal generators (48); and
a sampler (56) connected to the delaying circuits (52, 54).

6. The true random number generator according to claim 5, wherein each of the configurable signal generators (48) provides a delayed or inverted input signal according to the mode and comprises a configurable controller (58), a configurable multiplexer (59) and a configurable static random access memory array (60) connected to one another, wherein the configurable controller (58) automatically selects an output path of the configurable multiplexer (59) to achieve various delaying effects and avoid physical bias, thereby rendering the signal unpredictable.

7. The true random number generator according to claim 2, wherein the third random source (26) comprises:
delaying circuits (52, 54) each of which comprises configurable signal generators (48);
multiplexers (36, 38); and
inverters (46, 47) each of which comprises configurable signal generators (48), wherein the inverters (46, 47) are connected to the delaying circuits (52, 54) and the multiplexers (36, 38) and operable to determine a mode of the third random source (26) according to a selective signal.

8. The true random number generator according to claim 7, wherein each of the configurable signal generators (48) provides a delayed or inverted input signal according to the mode and comprises a configurable controller (58), a configurable multiplexer (59) and a configurable static random access memory array (60) connected to one another, wherein the configurable controller (58) automatically selects an output path of the configurable multiplexer (59) to achieve various delaying effects and avoid physical bias, thereby ensuring unpredictability.

9. The true random number generator according to claim 1, wherein the environmental sensor set (30) comprises a thermometer (32) and a voltmeter (34).

10. The true random number generator according to claim 9, wherein the thermometer (32) comprises a temperature sensor (66) and an analog-to-digital converter (62) connected to the temperature sensor (66).

11. The true random number generator according to claim 9, wherein the voltmeter (34) comprises a voltage sensor (68) and an analog-to-digital converter (64) connected to the voltage sensor (68).

12. The true random number generator according to claim 1, further comprising a post-processor (14) connected to the entropy harvester (12), wherein the post-processor (14) receives the random numbers from the entropy harvester (12) and renders them in a required format.

13. The true random number generator according to claim 12, wherein the post-processor (14) is further connected to the sampling controller (18) so that the post-processor (14) provides the sampling controller (18) with feedback as at least one unpredictable control signal for the random source set (20).

14. The true random number generator according to claim 12, further comprising a user interface (16) connected to the post-processor (14), wherein the user interface (16) provides random numbers.

15. The true random number generator according to claim 14, wherein the user interface (16) receives at least one external signal and is further connected to the sampling controller (18) so that the user interface (16) provides the sampling controller (18) with feedback as at least one unpredictable control signal for the random sources set (20).
